(19) United States
(12) Patent Application Publication
(10) Pub. No.: US 2021/0287472 A1
(43) Pub. Date: Sep. 16, 2021

(54) ATTENDANCE MANAGEMENT SYSTEM AND METHOD, AND ELECTRONIC DEVICE

(71) Applicant: SHENZHEN SENSETIME TECHNOLOGY CO., LTD., Shenzhen (CN)

(72) Inventors: Yao NIU, Shenzhen (CN); Baiding LI, Shenzhen (CN); Zhaohu XU, Shenzhen (CN); Wangjue HUANG, Shenzhen (CN); Dongdong ZUO, Shenzhen (CN); Wenzhong JIANG, Shenzhen (CN); Weihua XIAO, Shenzhen (CN)

(21) Appl. No.: 17/336,982

(22) Filed: Jun. 2, 2021

Related U.S. Application Data
(63) Continuation of application No. PCT/CN2019/114080, filed on Oct. 29, 2019.

(30) Foreign Application Priority Data
Dec. 27, 2018 (CN) 201811617662.8

(51) Int. Cl. G07C 9/37; G06F 16/2455; G06K 9/00; G06K 9/62

(52) U.S. Cl. CPC G07C 9/37; G06F 16/24558; G06K 9/00926; G06K 9/00288; G06K 9/00906; G06K 9/6215; G06K 9/6253

(57) ABSTRACT

An attendance management system includes: a cloud data platform, the cloud data platform storing registration information of an object subjected to an attendance check and an attendance record of the object, and the registration information comprising identity information and attribute information; at least one attendance terminal, each of the at least one attendance terminal exchanging data with the cloud data platform by means of a predetermined interface, and each attendance terminal being used to receive, by means of the predetermined interface, the registration information of the object transmitted by the cloud data platform; and an acquired facial image of the object. The attendance record includes at least one of the acquired facial image of the object, an attendance time, and an attendance region.

### CROSS-REFERENCE TO RELATED APPLICATION

This application is a continuation of International Application No. PCT/CN2019/114080, filed on Oct. 29, 2019, which claims priority to Chinese Patent Application No. 201811617662.8, filed on Dec. 27, 2018. The disclosures of International Application No. PCT/CN2019/114080 and Chinese Patent Application No. 201811617662.8 are hereby incorporated by reference in their entireties.

### BACKGROUND

At present, in order to strengthen the management on employees and make employees more punctual when going for or getting off work, companies use various methods for attendance management to record each employee's on-duty and off-duty time. With the development of the technology, the methods for attendance management have been changed from contact-type methods like swiping cards and fingerprint recognition into non-contact methods through facial recognition, bringing more and more convenient experience to employees.

However, the ways of providing services in the current attendance system are not flexible and inconvenient.

### SUMMARY

The present disclosure generally relates to the technical field of attendance checks, and more particularly, to a system and a method for attendance management and an electronic device.

The embodiments of the present disclosure provide a system for attendance management and an electronic device, the system can provide users with flexible and convenient services for attendance check.

In one aspect, the present disclosure provides a system for attendance management, which includes: a cloud data platform including a processor and a memory configured to store instructions executable by the processor, herein the memory has stored thereon registration information of an object to be subjected to an attendance check and an attendance record of the object to be subjected to the attendance check, and the registration information includes identity information and attribute information; and at least one attendance terminal, each of which performs data interaction with the cloud data platform through a predetermined interface, herein each attendance terminal includes a processor and a memory configured to store instructions executable by the processor, herein the processor of the attendance terminal is configured to: receive, through the predetermined interface, the registration information of the object to be subjected to the attendance check from the cloud data platform; and collect a facial image of the object to be subjected to the attendance check, herein the attendance record includes at least one of a collected facial image of the object to be subjected to the attendance check, an attendance time or an attendance area.

In another aspect, the present disclosure provides a method for attendance management, applied in a system for attendance management including a cloud data platform, and at least one attendance terminal, the method including: storing, by the cloud data platform, registration information of an object to be subjected to an attendance check and an attendance record of the object to be subjected to the attendance check, herein the registration information includes identity information and attribute information, the attendance record comprises at least one of a collected facial image of the object to be subjected to an attendance check, an attendance time or an attendance area, and the cloud data platform comprises a processor and a memory configured to store instructions executable by the processor; and sending, by the cloud data platform through a predetermined interface, the registration information of the object to be subjected to the attendance check to the at least one attendance terminal, herein the predetermined interface is used for data interaction performed by the cloud data platform with each of the at least one attendance terminal including a processor and a memory configured to store instructions executable by the processor.

In yet another aspect, the present disclosure provides a method for attendance management, applied in a system for attendance management including a cloud data platform and at least one attendance terminal, the method including: performing, by each of the at least one attendance terminal, data interaction with the cloud data platform through a predetermined interface, the attendance terminal including a processor and a memory configured to store instructions executable by the processor, herein the processor of each attendance terminal is configured to: receive, through the predetermined interface, registration information of an object to be subjected to an attendance check from the cloud data platform, and the cloud data platform includes a processor and a memory configured to store instructions executable by the processor; and collecting, by the at least one attendance terminal, a facial image of the object to be subjected to the attendance check.

### BRIEF DESCRIPTION OF THE DRAWINGS

In order to more clearly describe the technical solutions in the embodiments of the present disclosure or the related art, the drawings that need to be used in the description of the embodiments or the related art will be briefly introduced as follows. It is apparent that, the drawings in the following description are only some embodiments of the present disclosure. For those of ordinary skill in the art, other drawings can be obtained based on these drawings without creative work.

FIG. 1 is a schematic diagram of a system for attendance management provided by an embodiment of the present disclosure.

FIG. 2 is a schematic diagram showing interaction of a system for attendance management provided by an embodiment of the present disclosure.

FIG. 3 is a schematic diagram of another system for attendance management provided by an embodiment of the present disclosure.

FIG. 4 is a schematic diagram showing interaction of another system for attendance management provided by an embodiment of the present disclosure.

FIG. 5 is a schematic structural diagram of an attendance apparatus, provided by an embodiment of the present disclosure.

FIG. 6 is a schematic structural diagram of another attendance apparatus, provided by an embodiment of the present disclosure.

FIG. 7 is a schematic structural diagram of an electronic device provided by an embodiment of the present disclosure.

FIG. 8 is a schematic structural diagram of another electronic device provided by an embodiment of the present disclosure.

### DETAILED DESCRIPTION

The technical solutions in the embodiments of the present disclosure will be clearly and completely described below in conjunction with the drawings in the embodiments of the present disclosure. It is apparent that, the described embodiments are only a part of the embodiments of the present disclosure, rather than all the embodiments. Based on the embodiments of the present disclosure, all other embodiments obtained by those of ordinary skill in the art without creative work shall fall within the protection scope of the present disclosure.

It should be noted that the terms used in the embodiments of the present disclosure are only for the purpose of describing specific embodiments, and are not intended to limit the present disclosure. The singular forms of “a”, “said” and “the” used in the embodiments of the present disclosure and the appended claims are also intended to include plural forms, unless the context clearly indicates other meanings. It should also be understood that the term “and/or” used herein refers to and includes any or all possible combinations of one or more associated listed items.

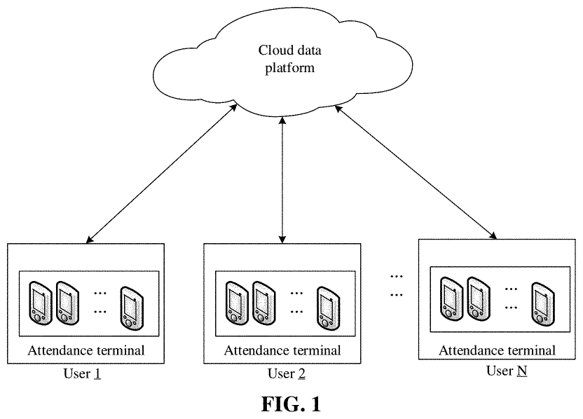

As shown in FIG. 1, which is a system for attendance management provided by an embodiment of the present disclosure, the system includes:

a cloud data platform having stored thereon registration information of an object to be subjected to an attendance check and an attendance record of the object to be subjected to the attendance check, herein the registration information includes identity information and attribute information; and

at least one attendance terminal, each of which performs data interaction with the cloud data platform through a predetermined interface, herein the attendance terminal is configured to: receive, through the predetermined interface, the registration information of the object to be subjected to the attendance check from the cloud data platform; and

the at least one attendance terminal is configured to collect a facial image of the object to be subjected to the attendance check, herein the attendance record includes at least one of a facial image of the object to be subjected to the attendance check, an identity identifier corresponding the to the facial image of the object to be subjected to the attendance check, an attendance time of the object to be subjected to the attendance check or an attendance area collected by the attendance terminal.

In some embodiments, the cloud data platform stores registration information of the object to be subjected to an attendance check, and the registration information includes identity information and attribute information, herein the identity information includes the identity identifier and biometric information of the object to be subjected to an attendance check, etc. The identity identifier may be the name or number of the object to be subjected to an attendance check. The biometric information includes at least features of the facial image of the object to be subjected to an attendance check, and may further include the fingerprint, pupil information or other biometric information of the object to be subjected to an attendance check. The attribute information includes information of a department to which the object to be subjected to an attendance check belongs, position information of the object to be subjected to an attendance check, and the like.

In some embodiments, the attendance terminal may be a terminal fixedly installed at the entrance of a company or a department, or a mobile device used by staff, such as a mobile phone, a tablet computer, and the like. The attendance terminal is installed with an attendance check application. Performing, by the attendance terminal, data interaction with the cloud data platform through a predetermined interface in the attendance check application includes receiving the registration information of the object to be subjected to an attendance check from the cloud data platform through the predetermined interface. The predetermined interface may be an interface based on a hypertext transfer protocol (HTTP). The predetermined interface may also be an interface based on a transmission control protocol (TCP). The predetermined interface may also be an interface based on a user datagram protocol (UDP). The present disclosure is not limited thereto. The predetermined interface predefines the format of data interaction between the attendance terminal and the cloud data platform, so that the data sent to each other by the attendance terminal and the cloud data platform can be mutually recognized by both parties.

In a possible implementation, the attendance terminal collects a facial image of the object to be subjected to an attendance check, and compares the facial image of the object to be subjected to an attendance check with a facial image pre-stored in the identity information to obtain a comparison result. In the case that the matching of facial image of the object to be subjected to an attendance check with any one of the facial images pre-stored in the identity information succeeds, the attendance terminal generates the attendance record according to the comparison result, and upload the attendance record to the cloud data platform. The attendance record includes at least the name or number of the object to be subjected to an attendance check, and the time point of the attendance of the object to be subjected to an attendance check.

In a possible implementation, the attendance terminal is only configured to collect a facial image of an object to be subjected to an attendance check, and then send the facial image of the object to be subjected to an attendance check to the cloud data platform. After receiving the facial image of the object to be subjected to the attendance check, the cloud data platform compares the facial image of the object to be subjected to an attendance check with a facial image pre-stored in the identity information to obtain a comparison result. In the case that the matching of the facial image of the object to be subjected to the attendance check with any one of the facial images pre-stored in the identity information succeeds, the cloud data platform generates the attendance record according to the comparison result.

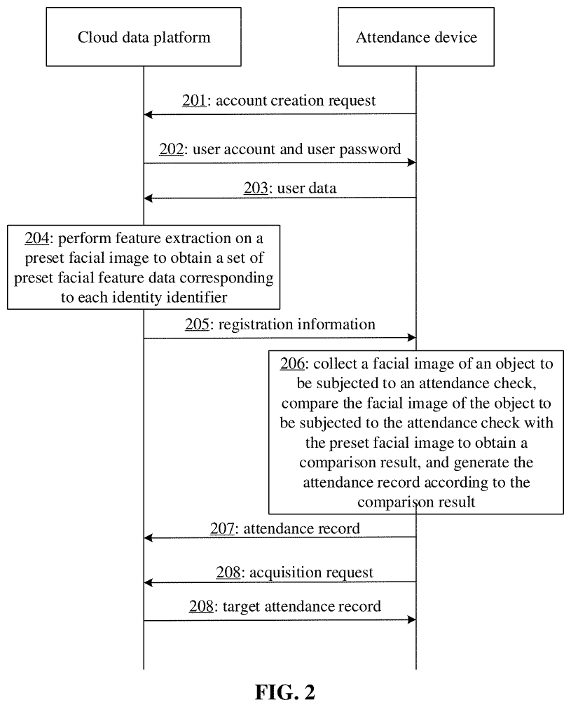

Specifically, please refer to FIG. 2, which is a schematic diagram showing interaction of a system for attendance management provided by an embodiment of the present disclosure. The system of this embodiment includes a cloud data platform and one or more attendance terminals. In some embodiments, taking one of the attendance terminals performing comparison on the facial image of the object to be subjected to an attendance check as an example to illustrate the interaction of the system for attendance management. As shown in FIG. 2, the interaction process of the system for attendance management includes the following operations.

In operation 201, the cloud data platform receives an account creation request from a user.

In some embodiments, before the user uses the cloud data platform, the attendance manager needs to send an account creation request to the cloud data platform through the website provided by the cloud data platform provider or the attendance check application on the attendance terminal, so as to apply to become a registered user. The account creation request is used to obtain usage authority to use the cloud data platform. The user may be a company, enterprise, school or government department that needs to perform attendance checks. In some embodiments, taking the user being a company as an example, the account creation request includes at least company information such as a name of the company, an organization code of the company, an address of the company, contact information of the company, and number of company staff.

It is to be understood that when the company has multiple attendance terminals, only one of attendance terminals is required to send the account creation request. Upon acquisition of a user account and a user password, the user account and the user password can be used to log in to the attendance check application on multiple attendance terminals.

In operation 202, the cloud data platform generates user account information according to the account creation request, and sends the user account information to the attendance terminal.

In some embodiments, after the cloud data platform receives a use request from the user, if it verifies that the user meets a usage condition, it is determined that the user has usage authority to use the cloud data platform. The cloud data platform randomly generates user account information including the user account and user password, and sends the user account and user password to the attendance terminal, or after the cloud data platform determines that the user has usage authority to use the cloud data platform, the administrator of the user sets an account and a password, and the administrator of the user can use the user account and the user password to log in to the cloud data platform.

In operation 203, the attendance terminal sends user data to the cloud data platform.

In some embodiments, the administrator of the user can use the user account and user password to log in to the cloud data platform and upload user data. The user data includes at least the company information of the company to which the attendance terminal belongs and the information of each staff. The company information includes at least the company name of the company, so that the cloud data platform can store the user data in the storage area corresponding to the company. The information of the staff includes an identity identifier of each staff, a preset facial image corresponding to each staff, and a department to which each staff belongs. The identity identifier may be the name or number of the staff. The preset facial image is the facial image pre-stored in the foregoing identity information. It can be understood that the user can send the user data to the cloud data platform through multiple attendance terminals. For example, different departments use their own attendance terminals to upload the user data corresponding to them.

In operation 204, the cloud data platform performs feature extraction on a preset facial image corresponding to each identity identifier to obtain a set of preset facial feature data corresponding to each identity identifier.

In some embodiments, after receiving the user data uploaded by the user through the attendance terminal, the cloud data platform performs feature extraction on the preset facial image corresponding to each staff in the user data to obtain a set of preset facial feature data corresponding to the preset facial image of each staff. The cloud data platform stores each identity identifier, the preset facial image corresponding to each identity identifier, and the preset facial feature data corresponding to each preset facial image in an associated manner, to obtain information set of the staff composed of the identity identifier, the preset facial image, and the preset facial feature data of each staff, that is, the identity information of each object to be subjected to an attendance check.

In some embodiments, the cloud data platform may perform feature extraction on the preset facial image by using machine learning methods, or perform feature extraction on the preset facial image by using deep learning methods. The machine learning methods include but are not limited to methods based on scale-invariant feature transform (SIFT), methods based on principal component analysis (PCA) and methods based on directional gradient histograms, etc. The deep learning methods include but are not limited to a convolutional neural network (CNN) model, a deep neural network (DNN) model and a recurrent neural network (RNN) model, etc. The embodiment of the present disclosure is not specifically limited thereto.

In operation 205, the cloud data platform sends the registration information of the object to be subjected to an attendance check to the attendance terminal.

In some embodiments, after obtaining an identity information of the object to be subjected to an attendance check, in combination with, the attribute information, the cloud data platform obtains the registration information of the user to be subjected to an attendance check, and sends the registration information to each attendance terminal through the predetermined interface.

In operation 206, the attendance terminal collects the facial image of the object to be subjected to an attendance check, compares the facial image of the object to be subjected to an attendance check with the preset facial image to obtain a comparison result, and generates the attendance record according to the comparison result.

In some embodiments, after collecting the facial image of the object to be subjected to an attendance check, the attendance terminal extracts the facial feature data of the facial image of the object to be subjected to an attendance check, and performs matching of the facial feature data of the facial image of the object to be subjected to an attendance check with the preset facial feature data. Responsive to that the matching of facial feature data of the facial image of the object to be subjected to an attendance check with any set of preset facial feature data succeeds, the attendance terminal generates an attendance record corresponding to this facial recognition. The attendance record includes at least a target identity identifier and the time point at which the facial image of the object to be subjected to an attendance check is collected by the attendance terminal. The target identity identifier is the identity identifier corresponding to the preset facial image that is successfully matched with the facial image of the object to be subjected to an attendance check.

In a possible embodiment, in the case that the matching of a facial image of an object to be subjected to an attendance check with a preset facial image succeeds, the attendance terminal sends control information to enable the access control door connected to the attendance terminal turn on.

In operation 207, the attendance terminal sends the attendance record to the cloud data platform.

Responsive to that the matching of a facial image of the object to be subjected to an attendance check with a preset facial image succeeds, the attendance terminal sends the attendance record corresponding to the object to be subjected to the attendance check to the cloud data platform. Since each company has at least one attendance terminal, each of which sends the attendance record generated by itself to the cloud data platform to generate target attendance record in the cloud data platform for all staffs of the company. It can be understood that the cloud data platform can provide multiple users with services for attendance checks at the same time. When sending the attendance record of the object to be subjected to an attendance check to the cloud data platform, the attendance terminal further needs to send the name of a company to which the attendance terminal belongs or the user account to the cloud data platform, so that the cloud data platform stores the attendance record of the object to be subjected to an attendance check to a corresponding storage area.

In operation 208, the cloud data platform receives the acquisition request from the attendance terminal, and sends the target attendance record to the attendance terminal.

In some embodiments, the acquisition request is configured to request the acquisition of the target attendance record. The acquisition request includes the user's company name or user account. The cloud data platform finds out the corresponding target attendance record according to the company name or the user account and sends the target attendance record to the attendance terminal.

The system for attendance management provided by the embodiments of the present disclosure can provide two kinds of attendance management schemes. One attendance management scheme is to collect the facial image of the object to be subjected to an attendance check at the attendance terminal, compare the facial image of the object to be subjected to an attendance check with a facial image pre-stored in the identity information, and complete the attendance check based on facial comparison. The other attendance management scheme is to send the facial image of the object to be subjected to an attendance check to the cloud data platform through the attendance terminal, and the attendance check based on facial comparison is completed by the cloud data platform. These two attendance management schemes are provided at the same time to meet the needs of different customers, and make the usage more flexible and convenient. For example, for companies with a small number of employees, the scheme of performing an attendance check based on the facial comparison at the attendance terminal can be selected. This scheme is economical and effective. For companies with a large number of employees, the scheme of performing an attendance check based on the facial comparison at the cloud data platform can be selected. This scheme improves the speed of facial recognition during an attendance check. At the same time, when the user chooses to use the cloud data platform for performing an attendance check based on the facial recognition, multiple users can share the services for attendance checks provided by one cloud data platform. When a user needs to introduce or replace an attendance system, he or she only needs to register to gain usage authority to use the cloud data platform, then he or she can use the services provided by the cloud data platform. In this way, it is possible to reduce economic pressure on the user, reduce resource waste, and improve the flexibility and convenience for the user to introduce the service for attendance checks.

In a possible embodiment, after collecting a facial image of the object to be subjected to an attendance check, the attendance terminal needs to send the facial image of the object to be subjected to the attendance check, and location information of the attendance terminal to the cloud data platform. When the location indicated by the location information is within the preset area, the cloud data platform performs the facial comparison and generates an attendance record. Alternatively, when the facial comparison is completed by the attendance terminal, the attendance record of the object to be subjected to an attendance check, and the location information of the attendance terminal need to be sent to the cloud data platform. When the location indicated by the location information is within a preset area, the cloud data platform determines that the attendance record is a qualified record.

In a possible embodiment, the cloud data platform or the attendance terminal is further configured to perform living body detection on the object to be subjected to an attendance check. Before the cloud data platform or the attendance terminal performs facial comparison on the facial image of the object to be subjected to an attendance check, living body detection need to be performed on the object to be subjected to an attendance check, Specifically, the attendance terminal plays a preset image sequence randomly when collecting the facial image of the object to be subjected to an attendance check and obtains the displayed image played on the display interface of the attendance terminal while capturing the facial image of the object to be subjected to the attendance check. When performing living body detection, the cloud data platform or the attendance terminal determines whether the reflection image in the human eyes of the facial image of the object to be subjected to an attendance check is identical to the displayed image. If they are the same, the living body detection is passed. If they are different, it indicates that the living body detection failed, the image ought to be re-entered.

In a possible embodiment, the system further includes a user interaction interface, the user interaction interface includes a login interface, the user inputs the user account and user password through the login interface. The cloud data platform responds to that the user account and user password pass verification, so as to enable the user to log in to the cloud data platform and perform operations on the data stored under the user account, such as adding user data, adding the registration information of the object to be subjected to an attendance check, and modifying the registration information of the object to be subjected to an attendance check, etc. It can be understood that the user interaction interface may be an interaction interface in the form of a web page, or an interaction interface provided by an attendance check application installed on the attendance terminal, which is not specifically limited in the embodiment of the application.

In a possible embodiment, the attendance terminal needs to be registered in the cloud data platform before being used. After the cloud data platform is authenticated, the cloud data platform will receive the facial image of the object to be subjected to an attendance check collected by the attendance terminal and/or the generated attendance record. For example, if the attendance terminal is a tablet computer, before using the tablet computer as the attendance terminal, the user needs to send the unique serial number corresponding to the tablet computer and the user account of the user to the cloud data platform through the attendance check application on the tablet computer. The cloud data platform binds the serial number to the user account, and then the registration of the tablet computer is completed. When sending the collected facial image of the object to be subjected to an attendance check and/or the generated attendance record to the cloud data platform, the tablet computer will also send the unique serial number of the tablet computer to the cloud data platform at the same time, so as to enable the cloud data platform find the user corresponding to the user account bound to the cloud data platform according to the unique serial number of the tablet computer, and then perform facial image matching or store attendance record in a corresponding storage area.

By registering the one or more attendance terminals, the cloud data platform can be enabled to shield the facial image or attendance record of the object to be subjected to an attendance check from the unregistered attendance terminals, thus it is possible to prevent staff from generating an invalid attendance record by providing the facial image or the attendance record of the object to be subjected to an attendance check through the unregistered attendance terminal before arriving the company or leaving the company early.

In a possible embodiment, when the above facial recognition method is applied in an access control system, the user data uploaded by the attendance terminal may further include staff group information of one or more staff groups and the attendance terminal information of one or more attendance terminals. Each identity identifier has an association relationship with at least one staff group, each staff group has an association relationship with at least one attendance terminal, and one staff group may be a department of a company. Table 1 is a table of association relationship among the identity identifiers, the staff groups, and the attendance terminals.

TABLE 1
Table of association relationship among the identity identifiers, the
staff groups, and the attendance terminals.

| | Identity | Serial Number of Attendance |
|---|---|---|
| Staff Group | Identifier | Terminal |
| Personnel Department | A0001 | E2018001 |
| | A0002 | |
| | A0003 | |
| | A0004 | |
| R&D department | A0001 | E2018002 |
| | A0004 | E2018003 |
| | A0005 | |
| | A0006 | |
| | A0007 | |
| | A0008 | |
| Testing Department | A0001 | E2018004 |
| | A0004 | E2018005 |
| | A0008 | |
| | A0009 | |
| | A0010 | |
| | A0011 | |
| Marketing Department | A0001 | E2018006 |
| | A0004 | |
| | A0008 | |
| | A0012 | |
| | A0013 | |

When a system for attendance management based on a cloud data platform is used in an access control system, the cloud data platform performs feature extraction on the preset facial image corresponding to each staff in the user data to obtain a set of preset facial feature data corresponding to the preset facial image of each staff. According to the association relationship existing between each identity identifier and at least one staff group and the association relationship existing between each staff group and at least one attendance terminal, the cloud data platform determines the association relationship between each identity identifier and at least one attendance terminal, and send each identity identifier and the set of preset facial feature data corresponding to each identity identifier to at least one attendance terminal having an association relationship with them. For example, the staff corresponding to the identity identifier A0008 in Table 1 can pass the access control of the R&D department, the testing department and the marketing department. According to the association relationship between these three departments and the attendance terminal in Table 1, after extracting and obtaining a set of preset facial feature data corresponding to the preset facial image of each staff, the cloud data platform sends the set of preset facial feature data corresponding to A0008 to the five attendance terminals installed at the entrances of these three departments. The staff whose identity identifier is A0009 only has the right to enter the testing department, the cloud data platform only sends a set of preset facial feature data corresponding to A0009 to the two attendance terminals corresponding to the testing department. When an attendance terminal at the entrance of any department collects a facial image of an object to be subjected to an attendance check, it extracts the facial feature data of the facial image of the object to be subjected to the attendance check, and performs matching of the facial image of the object to be subjected to the attendance check with the preset facial feature data in the attendance terminal. If the matching succeeds, it means that the staff corresponding to the facial image of the object to be subjected to the attendance check has the right to enter the department, and the attendance terminal will send an opening instruction to open the access control door at the entrance of this department.

By binding the identity identifier and preset facial feature data of the staff allowed to pass through the access control door of each department with the attendance terminal corresponding to the access control system of each department, the cloud data platform can be used for the access control system and its function of performing attendance checks can be realized.

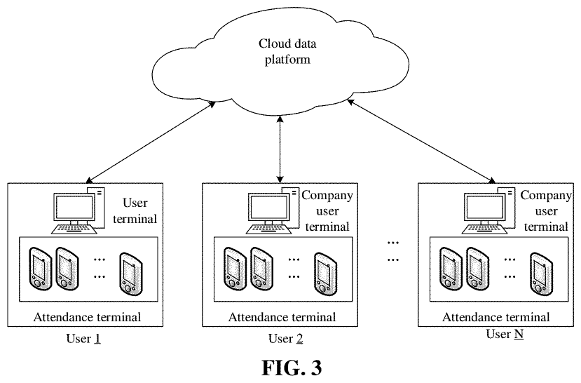

In a possible implementation, as shown in FIG. 3 that is another system for attendance management provided by an embodiment of the present disclosure, the system includes a cloud data platform, at least one user terminal and at least one attendance terminal. The system for attendance management further includes a user terminal. The user terminal may be a desktop computer, a portable computer, a tablet computer, and a mobile Internet device used by the company's department that manages the attendance check. The user terminal is configured to manage the registration information of the company and view the attendance record of the company staff on the cloud data platform. For example, the user terminal can log in to the attendance check application by using a user account and a user password, and then manage the corresponding user data in the cloud data platform through the user interface provided by the attendance check application. For example, the user terminal can perform operations through the attendance check application, such as uploading user data, adding, deleting or modifying user data and obtaining target attendance record.

In a possible embodiment, the user can manage registration information and attendance record on the cloud data platform by using an attendance management program developed by the user himself, and the cloud data platform can provide users with the application interface through which the attendance management program gets access to the cloud data platform. The application interface can enable the user to integrate the functions of the cloud data platform in the attendance management program. That is to say, the attendance management program can perform data interaction with the cloud data platform through the application interface.

By implementing the embodiments of the present disclosure, a user can register as a user of the cloud data platform, and after the user obtains usage authority to use the cloud data platform, he or she can upload registration information of an object to be subjected to an attendance check, and then the user is provided with a facial recognition-based service for attendance check. By establishing the cloud data platform, a user can implement attendance check based on facial recognition through either the cloud data platform or the attendance terminal, thus realizing a flexible attendance check. Furthermore, when the cloud data platform is adopted to perform attendance check based on facial recognition, one cloud data platform can provide the facial recognition-based service for attendance check to multiple company users at the same time, making it more flexible and convenient for the user to introduce the facial recognition-based service for attendance check.

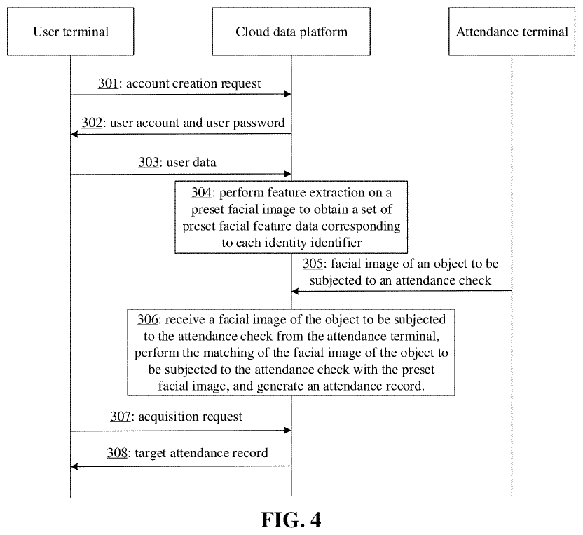

It can be understood that, when the user terminal is included in the system for attendance management, the user terminal can perform part of the functions of the attendance terminal. For example, the user terminal can perform the operation 201 or operation 203. Referring to FIG. 4, FIG. 4 is a schematic diagram showing interaction of another system for attendance management provided by an embodiment of the present disclosure. As shown in FIG. 4, the interactive process of the system for attendance management includes the following operations.

In operation 301, the cloud data platform receives an account creation request from a user.

In some embodiments, before the user uses the cloud data platform, the attendance manager needs to send an account creation request to the cloud data platform through a website provided by the cloud data platform provider or the attendance check application on the attendance terminal, so as to apply to become a registered user. Details are as described in operation 201 in the embodiment, and will not be repeated here. In some embodiments, the attendance manager sends the account creation request to the cloud data platform through the user terminal.

In operation 302, the cloud data platform generates user account information according to the account creation request, and sends the user account information to the user terminal.

In operation 303, the user terminal sends user data to the cloud data platform.

In operation 304, the cloud data platform performs feature extraction on the preset facial image corresponding to each identity identifier to obtain a set of preset facial feature data corresponding to each identity identifier.

In operation 305, after collecting a facial image of an object to be subjected to an attendance check, the attendance terminal sends the facial image of the object to be subjected to an attendance check to the cloud data platform.

The information sent by the attendance terminal to the cloud data platform further includes the user account of the company to which the attendance terminal belongs and the time point when the facial image of the object to be subjected to an attendance check is collected by the attendance terminal, so that the cloud data platform determines the company to which the facial image of the object to be subjected to an attendance check belongs and the work or off time of the staff corresponding to the facial image of the object to be subjected to an attendance check.

In operation 306, the facial image of the object to be subjected to an attendance check from the attendance terminal is received, matching of the facial image of the object to be subjected to an attendance check with the preset facial image is performed, and an attendance record is generated.

After receiving the facial image of the object to be subjected to an attendance check, the cloud data platform extracts the facial feature data of the facial image of the object to be subjected to the attendance check, and performs matching of the facial feature data of the facial image of the object to be subjected to the attendance check with a preset facial feature data. Responsive to that the matching of facial feature data of the facial image of the object to be subjected to the attendance check with any one set of preset facial feature data succeeds, a facial recognition record corresponding to this facial recognition is generated. The facial recognition record includes at least a target identity identifier and the time point when the facial image of the object to be subjected to an attendance check is collected by the attendance terminal. The target identity identifier is the identity identifier corresponding to the preset facial image successfully matching with the facial image of the object to be subjected to the attendance check.

The cloud data platform generates an attendance record corresponding to the target identity identifier according to the target identity identifier and the time point, and stores, according to the user account, the attendance record into the target attendance record corresponding to the user account, herein the target attendance record is the attendance records of all company staff.

In a possible embodiment, according to the facial recognition record, the cloud data platform generates the attendance record and/or staff attendance information corresponding to the target identity identifier in the facial recognition records, herein the staff attendance information includes the collection time of the facial image of the object to be subjected to an attendance check and the target identity identifier.

In a possible embodiment, responsive to that the matching of a facial image of the object to be subjected to an attendance check with a preset facial image succeeds, the cloud data platform sends control information to the attendance terminal, so that the attendance terminal can control the opening of the access control door connected to the attendance terminal.

In operation 307, the user terminal sends an acquisition request to the cloud data platform, herein the acquisition request is configured to request to the acquisition of target attendance record.

In some embodiments, the acquisition request includes the terminal identification code of the user terminal and the user account for logging in to the attendance check application on the terminal. The cloud data platform can identify the type of the user terminal according to the terminal identification code or the user account. If the user terminal is a user terminal used by the company's department that manages the attendance check, the user terminal can acquire the target attendance record of all staff in the company through the attendance check application. If the user terminal is a mobile phone or a tablet computer of the company staff, the staff can view their own attendance record through the attendance check application only.

In operation 308, the cloud data platform sends the target attendance record to the user terminal.

The above FIG. 2 and FIG. 3 only take the cloud data platform in the system for attendance management providing services for one user as an example for illustration. It can be understood that, when the cloud data platform provides services such as facial recognition for multiple users, the data interaction process between the cloud data platform and each user is identical to the above process. When the cloud data platform receives data uploaded by multiple users at the same time, the cloud data platform can process the received data in a parallel or serial manner, which is not specifically limited in the present disclosure.

By implementing the embodiments of the present disclosure, a user can register as a user of the cloud data platform, and after the user obtains usage authority to use the cloud data platform, he or she can upload registration information of an object to be subjected to an attendance check, and then the user is provided with a facial recognition-based service for attendance check. By establishing the cloud data platform, a user can implement attendance check based on facial recognition through either the cloud data platform or the attendance terminal, thus realizing a flexible attendance check. Furthermore, when the cloud data platform is adopted to perform attendance check based on the facial recognition, the service for the attendance check provided by one cloud data platform can be shared by multiple users. When a user needs to introduce or replace an attendance system, he or she only needs to register to gain usage authority to use the cloud data platform, then he or she can use the services provided by the cloud data platform. In this way, it is possible to reduce economic pressure on the user, reduce resource waste, and improve the flexibility and convenience for the user to introduce the service for attendance checks.

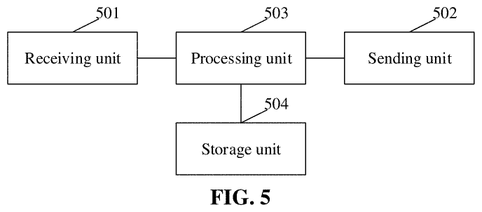

Please refer to FIG. 5, which is a schematic diagram of an attendance apparatus provided by an embodiment of the present disclosure. The attendance apparatus includes a receiving unit 501, a sending unit 502, a processing unit 503 and a storage unit 504.

The processing unit 503 is configured to manage the actions of the apparatus for the attendance check. For example, the processing unit 503 is configured to control the receiving unit 501 to perform the operation of receiving an account creation request in operation 201 in FIG. 2, receiving user data in operation 203 and receiving an attendance record in operation 207, or receiving a facial image of an object to be subjected to an attendance check in operation 305 in FIG. 4, and/or perform other receiving actions implemented by the cloud data platform described In some embodiments.

The sending unit 502 is configured to perform the operation of sending the user account and user password in operation 202 in FIG. 2, sending registration information in operation 205, and/or perform other sending functions implemented by the cloud data platform described In some embodiments.

The processing unit 503 is further configured to process user data. For example, the processing unit 503 is further configured to perform feature extraction on a preset facial image in operation 204 in FIG. 2, perform feature extraction on a preset facial image in operation 304 and generate an attendance record in 306 in FIG. 3, and/or perform other data processing functions implemented by the cloud data platform described in the embodiments of the present disclosure.

The storage unit 504 is configured to store user data and attendance record, and is further configured to store program codes and data. The processing unit 503 can invoke the program codes in the storage unit 504 to perform the functions implemented by the cloud data platform described in the above method embodiment.

It can be understood that, according to the functional description of the cloud data platform in the embodiments corresponding to FIG. 2 or FIG. 4, those skilled in the art can clearly know the implementation method of the attendance management of each unit included in the attendance apparatus. This will not be repeated here.

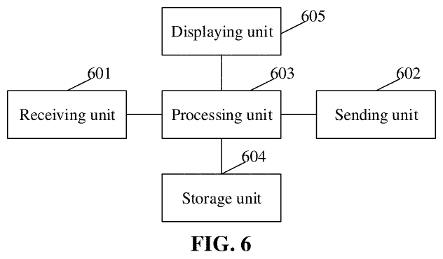

Please refer to FIG. 6, which is a schematic diagram of another attendance apparatus provided by an embodiment of the present disclosure. The attendance apparatus includes a receiving unit 601, a sending unit 602, a processing unit 603 and a storage unit 604.

The processing unit 603 is configured to manage the actions of the attendance apparatus. For example, the processing unit 603 is configured to control the receiving unit 601 to perform the action of receiving a user account and a user password in operation 202, receiving registration information in operation 205, receiving a target attendance record in operation 208 in FIG. 2, and/or perform other receiving actions implemented by the attendance terminal described In some embodiments.

The sending unit 602 is configured to perform the action of sending an account creation request in operation 201 and sending user data in operation 203 in FIG. 2, and/or perform other sending actions implemented by the attendance terminal described In some embodiments.

The processing unit 603 is further configured to process user data. For example, the processing unit 603 is further configured to perform the function of comparing a facial image of an object to be subjected to an attendance check with a preset facial image in operation 206 and generating an attendance record in FIG. 2, and/or perform other data processing functions implemented by the attendance terminal described in the embodiments of the present disclosure.

The storage unit 604 is configured to store registration information, and store program codes and data. The processing unit 603 can invoke the program codes in the storage unit 604 to perform the functions implemented by the attendance terminal described in the method embodiments.

The attendance terminal further includes a displaying unit 605 configured to display a user interaction interface, so as to enable the attendance manager to log in to the attendance check application by entering a user account and user password through the user interaction interface, manage user data in the cloud data platform, or play a preset image sequence when a facial image of an object to be subjected to an attendance check is collected.

It can be understood that, according to the functional description of the attendance terminal in the embodiment corresponding to FIG. 2 or FIG. 4, those skilled in the art can clearly know the implementation method of the attendance management of each unit included in the attendance apparatus. This will not be repeated here.

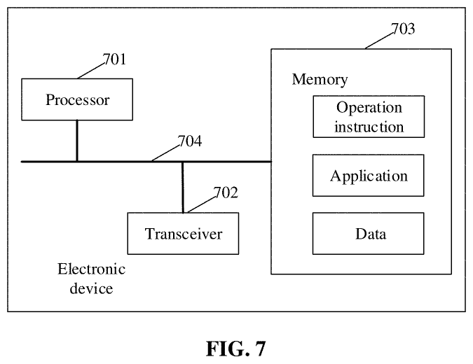

Please refer to FIG. 7, which is a schematic structural diagram of another electronic device provided by an embodiment of the present disclosure. The electronic device is applied in the system for attendance management to implement the functions of the cloud data platform. The electronic device includes a processor 701, an input and output device 702 and a memory 703. The processor 701, an input and output device 702 and the memory 703 are connected by a bus 704.

The processor 701 may be a central processing unit (CPU), and the processor may also be other general-purpose processors, digital signal processors (DSP), application specific integrated circuits (ASIC) and field-programmable gate array (FPGA) or other programmable logic devices, discrete gate or transistor logic devices, discrete hardware components, etc. The general-purpose processor may be a microprocessor or the processor may also be any conventional processor or the like.

The input and output device 702 may include a receiver and a transmitter, for example, a radio frequency module. Receiving or sending a certain message and/or data by a processor 701 described below can be specifically understood as receiving or sending by the processor 701 through the input and output device 702.

The memory 703 may include a read-only memory and a random access memory, and provide instructions and data to the processor 701. A part of the memory 703 may further include a non-volatile random access memory. In addition, the memory 703 can also store information of the type of the device.

In this embodiment, the processor 701 is configured to invoke the instructions stored in the memory 703 to implement the operations performed by the cloud data platform in operation 204, operation 205, or operation 208 in FIG. 2, or to implement the operations performed by the cloud data platform in operation 302, operation 304, or operation 306 in FIG. 4, and/or perform other functions implemented by the cloud data platform described in the embodiments of the present disclosure.

In some embodiments, the electronic device may be various terminal devices such as a desktop computer, a mobile Internet device (MID), and a server, which is not limited In some embodiments.

Specifically, according to the functional description of the cloud data platform in the embodiment corresponding to FIG. 2 or FIG. 4, those skilled in the art can clearly know the method of realizing attendance management implemented by each unit included in the electronic device. This will not be repeated here.

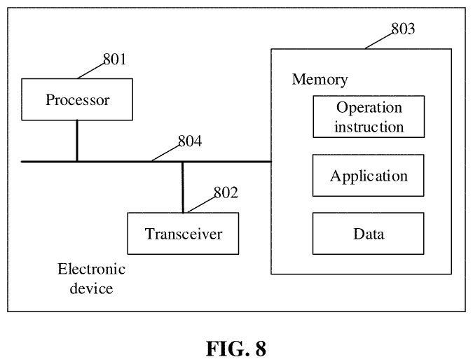

Please refer to FIG. 8, which is a schematic structural diagram of another electronic device provided by an embodiment of the present disclosure. The electronic device is applied in the system for attendance management to realize the functions of the cloud data platform. The electronic device includes a processor 801, an input and output device 802 and a memory 803. The processor 801, the input and output device 802 and the memory 803 are connected by a bus 804.

The processor 801 may be a CPU, and the processor may also be other general-purpose processors, DSPs, ASICs, FPGAs or other programmable logic devices, discrete gates or transistor logic devices, discrete hardware components, and the like. The general-purpose processor may be a microprocessor or the processor may also be any conventional processor or the like.

The input and output device 802 may include a receiver and a transmitter, for example, a radio frequency module. Receiving or sending a certain message and/or data by the processor 801 described below can be specifically understood as receiving or sending by the processor 801 through the input and output device 802.

The memory 803 may include a read-only memory and a random access memory, and provide instructions and data to the processor 801. A part of the memory 803 may further include a non-volatile random access memory. In addition, the memory 803 can also store information of the type of the device.

In this embodiment, the processor 801 is configured to invoke the instructions stored in the memory 803 to perform the operations implemented by the attendance terminal in operation 201, operation 203, operation 206, and operation 207 in FIG. 2, or to perform operations implemented by the attendance terminal in operation 301, operation 303, or operation 306 in FIG. 4, and/or perform other functional technologies implemented by the attendance terminal described in the embodiments of the present disclosure.

In some embodiments, the electronic device may be various terminal devices such as a desktop computer, a mobile Internet device (MID), and a server, which is not limited In some embodiments.

Specifically, according to the functional description of the attendance terminal in the embodiment corresponding to FIG. 2 or FIG. 4, those skilled in the art can clearly know the method of realizing the attendance management implemented by each unit included in the electronic device. This will not be repeated here.

Based on the same inventive concept, in another embodiment, a computer-readable storage medium is provided. The computer-readable storage medium stores computer programs. The computer programs include program instructions configured to implement, when being executed by a processor, the method described in any one of the method embodiments.

The computer-readable storage medium may be an internal storage unit of the terminal described in any one of the foregoing embodiments, such as the hard disk or memory of the terminal. The computer-readable storage medium may also be an external storage device of the terminal, such as a plug-in hard disk equipped on the terminal, a smart memory card (SMC), or a Secure Digital (SD) card or a Flash Card, etc. Further, the computer-readable storage medium may further include both an internal storage unit of the terminal and an external storage device. The computer-readable storage medium is configured to store the computer programs and other programs and data required by the terminal. The computer-readable storage medium can also be configured to temporarily store data that has been output or will be output.

Those skilled in the art may clearly understand that, for the convenience and conciseness of the description, the specific working process of the above-described system, apparatus and unit may refer to the corresponding procedures in the method embodiments, which will not be repeated here.

In addition, the functional units in each embodiment of the present disclosure may be integrated into one processing unit, or each unit may exist separately and physically, or two or more units may be integrated into one unit. The integrated units can be implemented in the form of hardware or software functional units.

If the function is implemented in the form of a software functional unit and is sold or used as an independent product, it can be stored in a computer readable storage medium. Based on such an understanding, the technical solutions of the present disclosure or the part that contributes to the related art or the part of the technical solutions may be embodied in the form of a software product essentially, and the computer software product is stored in a storage medium including several indications to make a computer device (which may be a personal computer, a server or a network device, etc.) execute all or part of the operations of the methods described in the each embodiment of the present disclosure. The storage medium includes: U disks, mobile hard disks, read-only memories (ROM), random access memories (RAM), magnetic disks or optical disks and other media that can store program codes.

The foregoing description is only the specific implementation of the present disclosure. However, the protection scope of the present disclosure is not limited thereto. Any variations or replacements apparent to those skilled in the art within the technical scope disclosed by the present disclosure shall fall within the protection scope of the present disclosure. Therefore, the protection scope of the present disclosure shall be subjected to the protection scope of the claims.

1. A system for attendance management, the system comprising:
a cloud data platform comprising a processor and a memory configured to store instructions executable by the processor, wherein the memory has stored thereon registration information of an object to be subjected to an attendance check and an attendance record of the object to be subjected to the attendance check, and the registration information comprises identity information and attribute information; and
at least one attendance terminal, each of which performs data interaction with the cloud data platform through a predetermined interface, wherein each attendance terminal comprises:
a processor; and
a memory configured to store instructions executable by the processor,
wherein the processor of the attendance terminal is configured to:
receive, through the predetermined interface, the registration information of the object to be subjected to the attendance check from the cloud data platform; and
collect a facial image of the object to be subjected to the attendance check, wherein the attendance record comprises at least one of a collected facial image of the object to be subjected to the attendance check, an attendance time or an attendance area.

2. The system of claim 1, wherein the processor of the at least one attendance terminal is further configured to compare the facial image of the object to be subjected to the attendance check with a facial image pre-stored in the identity information to obtain a comparison result, generate the attendance record according to the comparison result and send the attendance record to the cloud data platform; or
the processor of the at least one attendance terminal is further configured to send the collected facial image of the object to be subjected to the attendance check to the cloud data platform,
wherein the processor of the cloud data platform is further configured to receive the facial image of the object to be subjected to the attendance check from the attendance terminal, compare the facial image of the object to be subjected to the attendance check with the facial image pre-stored in the identity information to obtain the comparison result, and generate the attendance record according to the comparison result.

3. The system of claim 1, wherein the processor of the cloud data platform is further configured to: receive an account creation request from a user; and
generate user account information according to the account creation request.

4. The system of claim 3, further comprising a user interaction interface comprising a login interface,
wherein the processor of the cloud data platform receives user account information input by the user through the login interface; and
responsive to that the user account information passes verification, the processor of the cloud data platform enables the user to log in to the cloud data platform and perform operations on the cloud data platform.

5. The system of claim 1, wherein the predetermined interface comprises a hypertext transfer protocol interface.

6. The system of claim 1, further comprising:
an application interface through which a user terminal gets access to the cloud data platform to obtain the attendance record.

7. The system of claim 1, wherein the processor of the cloud data platform is further configured to:
receive the facial image of the object to be subjected to the attendance check and location information of the attendance terminal from the attendance terminal, and responsive to that a location indicated by the location information is within a preset area, generate the attendance record after matching of the facial image of the object to be subjected to the attendance check with a preset facial image in the identity information succeeds.

8. The system of claim 1, wherein the processor of the cloud data platform or the attendance terminal is further configured to perform living body detection on the object to be subjected to the attendance check.

9. The system of claim 8, wherein the processor of the cloud data platform or the attendance terminal being further configured to perform the living body detection on the object to be subjected to the attendance check comprises:
playing, by the processor of the attendance terminal, a preset image sequence;
collecting, by the processor of the attendance terminal, the facial image of the object to be subjected to the attendance check, and obtaining a displayed image played when the facial image of the object to be subjected to the attendance check is collected; and
determining that the facial image of the object to be subjected to the attendance check is a facial image of a living body, when the processor of the cloud data platform or the attendance terminal determines that a reflection image in eyes of the facial image of the object to be subjected to the attendance check is identical to the displayed image.

10. A method for attendance management, applied in a system for attendance management comprising a cloud data platform and at least one attendance terminal, the method comprising:
storing, by the cloud data platform, registration information of an object to be subjected to an attendance check and an attendance record of the object to be subjected to the attendance check, wherein the registration information comprises identity information and attribute information, the attendance record comprises at least one of a collected facial image of the object to be subjected to an attendance check, an attendance time or an attendance area, and the cloud data platform comprises a processor and a memory configured to store instructions executable by the processor; and
sending, by the cloud data platform through a predetermined interface, the registration information of the object to be subjected to the attendance check to the at least one attendance terminal, wherein the predetermined interface is used for data interaction performed by the cloud data platform with each of the at least one attendance terminal comprising a processor and a memory configured to store instructions executable by the processor.

11. The method of claim 10, further comprising:
receiving, by the cloud data platform, the attendance record, wherein the attendance record is generated by the attendance terminal according to a comparison result obtained after the attendance terminal compares the facial image of the object to be subjected to the attendance check with a facial image pre-stored in the identity information; or
receiving, by the cloud data platform, the facial image of the object to be subjected to the attendance check from the attendance terminal, and generating the attendance record according to a comparison result obtained after the cloud data platform compares the facial image of the object to be subjected to the attendance check with the facial image pre-stored in the identity information.

12. The method of claim 10, further comprising:
receiving, by the cloud data platform, an account creation request from a user; and
generating user account information according to the account creation request.

13. The method of claim 12, further comprising:
receiving, by the cloud data platform, the user account information input by the user through a login interface of a user interaction interface; and
responsive to that the user account information passes verification, enabling, by the cloud data platform, the user to log in to the cloud data platform and perform operations on the cloud data platform.

14. The method of claim 10, wherein the predetermined interface comprises a hypertext transfer protocol interface.

15. The method of claim 10, further comprising:
sending, by the cloud data platform, the attendance record to a user terminal through an application interface, wherein the application interface is used by the user terminal to get access to the cloud data platform.

16. The method of claim 10, further comprising:
receiving, by the cloud data platform, the facial image of the object to be subjected to the attendance check and location information of the attendance terminal from the attendance terminal, and responsive to that a location indicated by the location information is within a preset area, generating the attendance record after matching of the facial image of the object to be subjected to the attendance check with a preset facial image in the identity information succeeds.

17. The method of claim 10, further comprising:
performing, by the cloud data platform, living body detection on the object to be subjected to the attendance check.

18. A method for attendance management, applied in a system for attendance management comprising a cloud data platform and at least one attendance terminal, the method comprising:
performing, by each of the at least one attendance terminal, data interaction with the cloud data platform through a predetermined interface, the attendance terminal comprising a processor and a memory configured to store instructions executable by the processor, wherein the processor of each attendance terminal is configured to receive, through the predetermined interface, registration information of an object to be subjected to an attendance check from the cloud data platform, wherein the registration information comprises identity information and attribute information, and the cloud data platform comprises a processor and a memory configured to store instructions executable by the processor; and
collecting, by the at least one attendance terminal, a facial image of the object to be subjected to the attendance check.

19. A non-transitory computer-readable storage medium having stored thereon instructions that, when executed by a processor, cause the processor to implement the method of claim 10.

20. A non-transitory computer-readable storage medium having stored thereon instructions that, when executed by a processor, cause the processor to implement the method of claim 18.
